(19) United States
(12) Patent Application Publication
(10) Pub. No.: US 2021/0366304 A1
(43) Pub. Date: Nov. 25, 2021

(54) SIMULATED DROP TRAINING APPARATUS HAVING TRAINING INFORMATION DISPLAY FUNCTION

(71) Applicant: GENTOP CO., LTD, Changwon-si, Gyeongsangnam-do (KR)

(72) Inventor: Hong-Dae PARK, Changwon-si, Gyeongsangnam-do (KR)

(21) Appl. No.: 17/251,073

(22) PCT Filed: Dec. 18, 2019
(86) PCT No.: PCT/KR2019/018035

§ 371 Date: Dec. 10, 2020

(30) Foreign Application Priority Data
Nov. 1, 2019 (KR) 10-2019-0138787

(51) Int. Cl. G09B 9/00; G01G 19/44; G01G 23/18

(52) U.S. Cl. CPC G09B 9/00; G01G 23/18; G01G 19/44

(57) ABSTRACT

A simulated drop training apparatus having a training information display function is proposed. An information display device configured to visually display training information on the ground is provided in the simulated drop training apparatus, so that an external manager, such as a training instructor or the like, or a trainee performing simulated drop training may intuitively become aware of training information, thereby providing the effect of improving the controllability and performance of the simulated drop training.

### TECHNICAL FIELD

The present invention relates to a simulated drop training apparatus having a training information display function.

This application claims priority based on Korean Patent Application No. 10-2019-0138787 filed on Nov. 1, 2019, and all contents described in the specification and drawings of the application are incorporated herein by reference.

### BACKGROUND ART

In general, parachute descent training is a training in which a trainee jumps with a parachute from an aircraft or helicopter at a certain altitude and then lands on the ground. Since it was expensive to actually use an aircraft or helicopter, there was developed a simulated drop training apparatus that enabled parachute descent training to be performed on the ground.

A simulated drop training apparatus is configured to enable actual training, in which an aircraft or helicopter is taken off from the ground and a trainee jumps at a certain altitude, to be performed under real-world conditions without operating an aircraft or helicopter by installing a virtual simulator on the ground. The simulated drop training apparatus enables training even in situations in which an aircraft or helicopter cannot take off and land due to weather conditions such as bad weather.

Furthermore, the simulated drop training apparatus can prevent accidents that may occur during parachute training in an aircraft or helicopter in advance, and can reduce fuel consumption that results from the operation of the aircraft or helicopter.

Meanwhile, even when drop training is performed using the simulated drop training apparatus, the safety of simulated drop training, such as the prevention of the accidental fall of a trainee, must be ensured because a trainee performs drop training at a position spaced apart from the ground by a predetermined height.

Furthermore, there is a need to ensure the controllability and performance of simulated drop training by providing training information based on the progress of the simulated drop training so that an external manager (a training instructor or the like) and a trainee may become aware of the training information in real time.

### DISCLOSURE

### Technical Problem

An object of the present invention is to provide a simulated drop training apparatus that is provided with an information display device configured to visibly display training information on the ground, thereby providing the improved controllability and performance of simulated drop training.

Another object of the present invention is to provide a simulated drop training apparatus that is provided with a weight sensor configured to collect the weight information of a trainee performing simulated drop training and is configured to output the collected weight information via an information display device, so that information about the physical conditions of the trainee can be easily determined, thereby ensuring the safety of simulated drop training.

The objects of the present invention are not limited thereto, and other objects not mentioned will be clearly understood by those skilled in the art from the following description.

### TECHNICAL SOLUTION

In order to accomplish the above objects, an embodiment of the present invention provides a simulated drop training apparatus having a training information display function, the simulated drop training apparatus including: a body part fixedly installed onto a support means that is provided at a simulated drop training site; a drop driving unit provided inside the body part, and configured to lift or lower a trainee according to training motion by winding or unwinding binding wires connected to the trainee's suit; and an information display device provided at the lower end of the body part, and configured to output training information about simulated drop training onto the ground through a predetermined light beam.

Furthermore, the drop driving unit is provided with a weight sensor configured to collect the weight information of the trainee by measuring the load transmitted to the drop driving unit through the binding wires.

Furthermore, the information display device receives the weight information of the trainee from the weight sensor and outputs the training information including the weight information of the trainee.

Furthermore, the training information includes at least one of trainee information including information about the physical conditions of the trainee and landing point information indicating the landing point of the trainee according to the landing motion of the training motion.

Furthermore, the information display device changes the color of the light beam according to the training motion and then outputs the training information.

Furthermore, the information display device is rotatably coupled to the body part so that the position of the training information displayed on the ground can be changed by adjusting the radiation angle of the light beam.

Moreover, a base pad configured to alleviate the impact that is applied to the trainee when the trainee lands on the ground according to the training motion is installed on the ground above which the body part is fixedly installed.

### Advantageous Effects

According to an embodiment of the present invention, the information display device configured to visually display training information on the ground is provided in the simulated drop training apparatus, so that an external manager, such as a training instructor or the like, or a trainee performing simulated drop training may intuitively become aware of training information, thereby providing the effect of improving the controllability and performance of the simulated drop training.

Furthermore, the weight sensor configured to collect the weight information of a trainee performing simulated drop training is provided in the simulated drop training apparatus and the collected weight information is configured to be output via the information display device, so that information about the physical conditions of the trainee performing the simulated drop training may be easily determined, thereby providing the effect of ensuring the safety of simulated drop training.

### DESCRIPTION OF DRAWINGS

FIG. 1 is a perspective view showing the overall configuration of a simulated drop training apparatus according to an embodiment of the present invention;

FIG. 2 is a perspective view showing the overall configuration of a body part according to an embodiment of the present invention;

FIG. 3 shows plan and front views showing the overall configuration of a drop driving unit according to an embodiment of the present invention;

FIG. 4 is a perspective view showing a state in which a seating depression is formed in the body part according to the embodiment of the present invention;

FIG. 5 is a right side view showing a state in which the angle at which the information display device according to the embodiment of the present invention outputs training information is changed;

FIG. 6 is a perspective view showing a state in which the trainee information of training information according to an embodiment of the present invention is displayed on the ground;

FIG. 7 is a perspective view showing a state in which the training situation information of the training information according to the embodiment of the present invention is displayed on the ground;

FIG. 8 is a perspective view showing a state in which the landing point information of the training information according to the embodiment of the present invention is displayed on the ground;

FIG. 9 is a block diagram showing the overall configuration of a simulated drop training apparatus according to an embodiment of the present invention; and

FIG. 10 is a block diagram showing a simulated drop training apparatus according to an embodiment of the present invention, which includes a remote control device.

### DESCRIPTION OF REFERENCE SYMBOLS

100: body part 110: housing

111: first wire holes 113: second wire holes

115: rotating shaft support part 115a: coupling hole

117: seating depression 119: operating state display portions

130: mounting brackets 150: binding wires

170: control wires

200: drop driving unit 210: rotation unit

211: rotating plate 213: rotating shaft

215: load unit 230: driving motor

250: first control unit

300: information display device 310: driving unit

311: first driving unit 313: second driving unit

330: second control unit 350: output unit

400: weight sensor 500: base pad

600: remote control device

i: training information i-1: trainee information

i-1w: weight information i-2: training situation information

i-3: landing point information

SC-1: driving motor control signal SC-2: driving unit control signal

SC-3: output unit control signal S 1: drop driving unit control signal

S2: information display device control signal

### MODE FOR INVENTION

Some embodiments of the present invention will be described in detail below through exemplary drawings. In the assignment of reference numerals to the elements of individual drawings, it should be noted that the same elements are assigned the same numerals as much as possible even when they are shown on different drawings. Furthermore, in the description of the present invention, when it is determined that a detailed description of a related known configuration or function may obscure the gist of the present invention, a detailed description thereof will be omitted.

Furthermore, in the description of the components of the present invention, terms such as first, second, A, B, (a), and (b) may be used. These terms are only used to distinguish corresponding components from other components, and the natures, sequence, or sequential positions of the components are not limited by these terms. When a component is described as being “connected,” “coupled,” or “jointed” to another component, it should be understood that the former component may be directly connected or joined to the other component but a third component may be “connected,” “coupled,” or “jointed” between the former components.

As shown in the drawings, a simulated drop training apparatus having a training information display function according to an embodiment of the present invention includes: a body part 100 fixedly installed onto a support means that is provided at a simulated drop training site; a drop driving unit 200 provided inside the body part 100, and configured to lift or lower a trainee according to training motion by winding or unwinding binding wires 150 connected to the trainee's suit; and an information display device 300 provided at the lower end of the body part 100 and configured to output training information ‘i’ about simulated drop training onto the ground through a predetermined light beam.

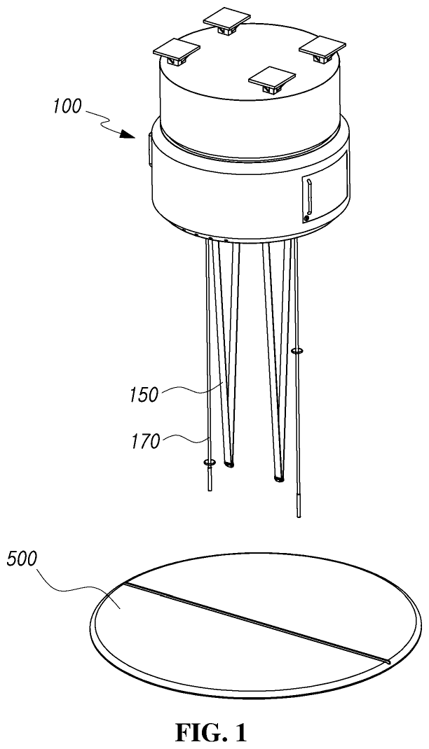

The individual components of the present invention will be described in detail below with reference to FIGS. 1 to 10.

First, the body part 100 is fixedly installed onto the support means provided at the simulated drop training site.

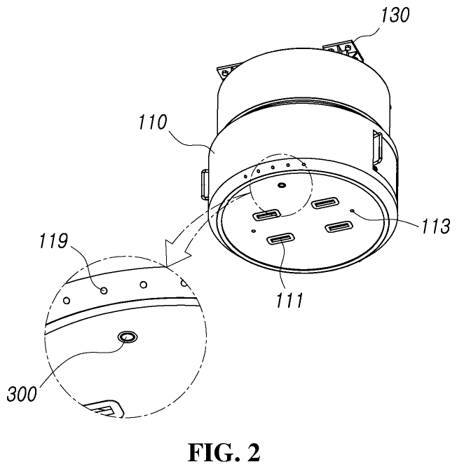

More specifically, as shown in FIG. 2, the body part 100 according to an embodiment of the present invention includes: a housing 110 configured such that a part accommodation space is formed therein and parts for driving the simulated drop training apparatus are installed therein; and mounting brackets 130 coupled to the upper end of the housing 110, and fastened to the support means provided at the simulated drop training site.

First, the housing 110 may be provided as a cylindrical member in which a part accommodation space is formed.

Various parts for driving the simulated drop training apparatus are installed in the part accommodation space that is formed inside the housing 110. As an example, there may be installed the drop driving unit 200 configured to lift or lower a trainee. For this purpose, a rotating shaft support part 115 configured to allow the drop driving unit 200 to be installed may be formed inside the lower end of the housing 110. This will be described in detail below.

Meanwhile, first wire holes 111 configured to pass binding wires 150 through the part accommodation space and second wire holes 113 configured to pass control wires 170 through the part accommodation space may be formed in the outside of the lower end of the housing 110.

First, the binding wires 150 are members that mediate between the drop driving unit 200 and the trainee in a state in which the first ends thereof are connected to the drop driving unit 200 and the second ends thereof are connected to the trainee's suit (as an example, a harness). The trainee may be lifted or lowered according to training motion by winding or unwinding the binding wires 150 via the drop driving unit 200.

Although the first wire holes 111 are formed through the lower end of the housing 110 and four first wire holes 111 are illustrated as being formed in FIG. 2, they are not limited there to. The first wire holes 111 may be formed in various numbers and shapes according to design.

The binding wires 150 may be passed through the first wire holes 111 and located outside the housing 110 with the first ends thereof connected to the drop driving unit 200. The trainee may perform simulated drop training by connecting the binding wires 150, suspended outside, to his or her suit.

Next, the control wires 170 are members that are provided to be controlled in a state in which the first ends thereof are connected to a rotation driving unit (not shown) and the second ends thereof are gripped by the trainee. The trainee may be rotated in one direction or its opposite direction according to training motion by rotating the lower end of the housing 110 by the rotation driving unit (not shown).

In this case, the rotation driving unit (not shown) may rotate the lower end of the housing 110 in one direction or its opposite direction according to an action in which the trainee pulls the control wires 170. For example, when the trainee pulls the control wire 170, held in his or her right hand, downward, the rotation driving unit (not shown) may be driven to rotate the lower end of the housing 110 in a right direction. When the trainee pulls the control wire 170, held by his or her left hand, downward, the rotation driving unit (not shown) may be driven to rotate the lower end of the housing 110 in a left direction.

Meanwhile, the lower end of the housing 110 may be formed to be separate from the sidewall of the housing 110 so that the lower end of the housing 110 can be rotated in one direction or its opposite direction by the rotation driving unit (not shown).

The second wire holes 113 are formed through the lower end of the housing 110. As shown in FIG. 2, two second wire holes may be formed such that the two control wires 170 gripped by the trainee in the right hand and the left hand can pass there through.

The control wires 170 may be passed through the second wire holes 113 and positioned outside the housing 110 with the first ends there of connected to the rotation driving unit (not shown). The trainee may perform simulated drop training by gripping and manipulating the control wires 170, suspended outside, in his or her right and left hands, respectively.

Next, a plurality of operating state display portions 119 configured to indicate the operating state of the simulated drop training apparatus may be provided on the outside of the lower end of the housing 110. The operating state display portions 119 may be provided as, e.g., LEDs, and are provided to be flashed when the simulated drop training apparatus is in operation or is not in operation.

Meanwhile, the body part 100 is fixedly installed onto the support means provided in the simulated drop training site. In this case, the simulated drop training site in which the body unit 100 is installed may be an indoor or outdoor site, and the support means provided at the simulated drop training site may be, e.g., an H-beam member.

More specifically, the simulated drop training apparatus according to an embodiment of the present invention is fixed to the support means provided at the simulated drop training site by the mounting brackets 130 that are coupled to the upper end of the housing 110. In this case, the mounting brackets 130 may be securely fastened to the H-beam or the like by fastening means such as bolts.

Next, the drop driving unit 200 is provided inside the body part 100, and winds or unwinds the binding wires 150 connected to the trainee's suit, thereby lifting or lowering the trainee according to the training motion.

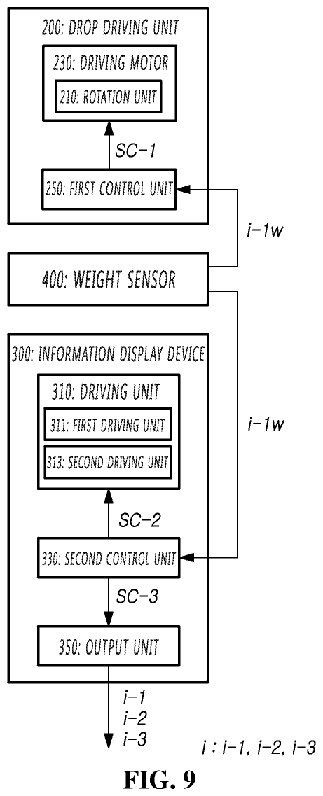

More specifically, as shown in FIGS. 2 and 9, the drop driving unit 200 according to an embodiment of the present invention may include: a rotation unit 210 configured to lift or lower the trainee according to the training motion by winding or unwinding the binding wires 150; a driving motor 230 configured to provide driving force to the rotation unit 210; and a first control unit 250 configured to control the operation of the driving motor 230.

First, the rotation unit 210 is a means for winding or unwinding the binding wires 150 connected to the trainee. The rotation unit 210 includes: a rotating plate 211 configured such that the binding wires 150 are wound thereon or unwound therefrom; a rotating shaft 213 coupled through the central portion of the rotating plate 211; and a load unit 215 coupled to the other end of the rotating shaft 213, and configured to transmit a load, applied to the rotation unit 210 by the binding wires 150, to a weight sensor 400 to be described later.

The rotating plate 211 may be formed as a disk shape as an example in order to wind or unwind the binding wires 150 connected to the trainee. The binding wires 150 may be wound along or unwound from a groove formed in the rotating plate 211.

Next, the rotating shaft 213 is a member that transmit the rotational force provided from the drive motor 230 to the rotating plate 211 in a state in which one end of the rotating shaft 213 is coupled to the drive motor 230 to be described later and the central portion of the rotating shaft 213 is passed through the center of the rotating plate 211. The rotating plate 211 may wind or unwind the binding wires 150 by being rotated by the transmitted rotational force.

Furthermore, the rotating shaft 213 is coupled to the rotating shaft support part 115 formed inside the lower end of the above-described housing 110.

More specifically, the rotating shaft 213 is coupled to the rotating shaft support part 115 through the coupling hole 115a formed in the rotating shaft support part 115.

The rotating shaft 213 is coupled to the rotating shaft support part 115, and thus the rotation unit 210 is fixedly installed inside the housing 110.

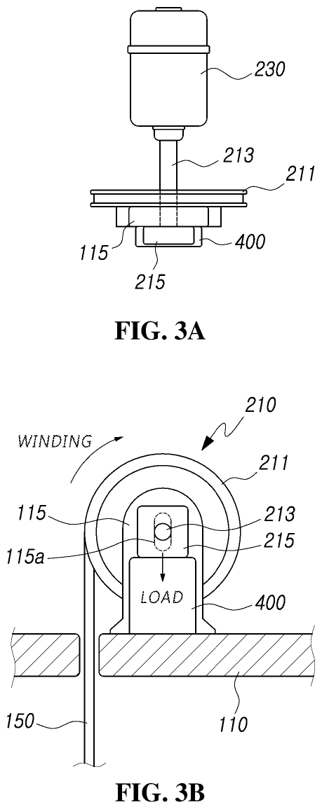

In this case, the coupling hole 115a formed in the rotating shaft support part 115 is formed in a slot shape, as shown in FIG. 3B. Accordingly, when the load attributable to the binding wires 150 is applied to the rotation unit 210, the rotating shaft 213 may be moved along the coupling hole 115a.

Next, the load unit 215 is coupled to the other end of the rotating shaft 213, and thus the load applied to the rotation unit 210 by the binding wires 150 is transferred to the weight sensor 400.

When the binding wires 150 are wound or unwound along the rotating plate 211, a predetermined load attributable to the weight of the trainee connected to the binding wires 150 is applied to the rotating plate 211.

The load applied to the rotating plate 211 may be sequentially transferred to the rotating shaft 213 connected to the rotating plate 211 and the load unit 215 coupled to the rotating shaft 213. The load transferred to the load unit 215 may be transferred to the weight sensor 400 installed to come into contact with the bottom surface of the load unit 215, and may be measured by the weight sensor 400.

Next, the driving motor 230 is connected to one end of the rotating shaft 213, and provides rotating force, used to wind or unwind the binding wires 150, to the rotating shaft 213.

As described above, the rotating plate 211 is coupled to the central portion of the rotating shaft 213, and thus the rotating plate 213 may be rotated by the rotating force provided to the rotating shaft 213.

Next, the first control unit 250 is a means for controlling the driving of the driving motor 230, and controls the rotation speed and RPM of the driving motor 230 in response to a driving motor control signal SC-1.

In particular, the first control unit 250 may receive predetermined information or a predetermined signal from the weight sensor 400 or a remote control device 600 to be described later, may generate the driving motor control signal SC-1 based on the information or signal, and may then control the driving motor 230. This will be described in detail below.

Next, the information display device 300 is provided at the lower end of the body part 100, and outputs training information ‘i’ about simulated drop training onto the ground through a predetermined light beam.

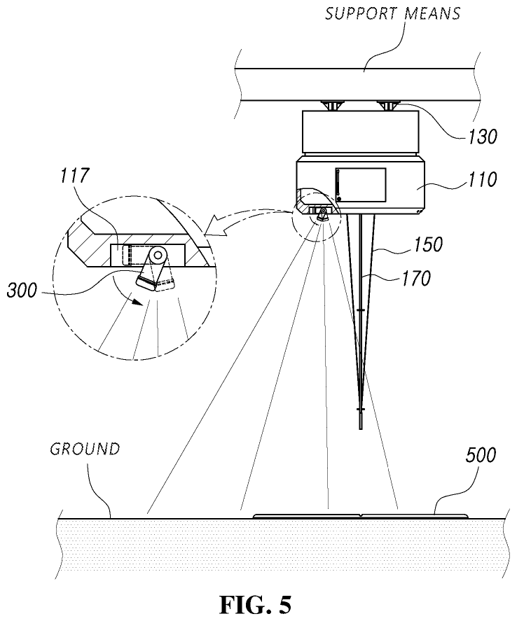

More specifically, as shown in FIGS. 5 and 9, the information display device 300 according to an embodiment of the present invention includes: a driving unit 310 configured to rotate the information display device 300 or rotate the output unit 350 provided in the information display device 300; an output unit 350 configured to output training information ‘i’ about the simulated drop training onto the ground; and a second control unit 330 configured to control the operations of the driving unit 310 and the output unit 350.

First, although the information display device 300 according to an embodiment of the present invention may be installed in the lower end of the housing 110 in a recessed state, as shown in FIG. 2, the information display device 300 is rotatably coupled to the body part 100 so that the position of the training information ‘i’ displayed on the ground can be changed by adjusting the radiation angle of a light beam.

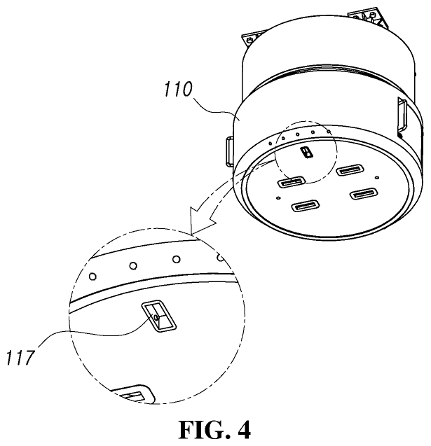

More specifically, the information display device 300 is rotatably coupled to the lower end of the housing 110. In this case, a seating depression 117 is formed in the outside of the lower end of the housing 110, as shown in FIG. 4, and thus the information display device 300 may be configured to be accommodated in or protrude from the seating depression 117 through rotation.

Meanwhile, the information display device 300 is characterized in that it is rotatably coupled to the lower end of the housing 110 and thus the position where the training information ‘i’ is displayed on the ground is changed by adjusting the angle of the information display device 300. For this purpose, the driving unit 310 provided in the information display device 300 may include a first driving unit 311 configured to rotate the information display device 300 with respect to the housing 110.

As the first driving unit 311 is provided, the information display device 300 maybe rotated with respect to the housing 110 by a predetermined angle, as shown in FIG. 5. Accordingly, the training information ‘i’ output from the output unit 350 of the information display device 300 may be adjusted to be displayed at different positions on the ground.

Furthermore, the driving unit 310 may include a second driving unit 313 configured to rotate the output unit 350 in a circumferential direction so that the direction in which the training information ‘i’ output from the output unit 350 provided in the information display device 300 is displayed on the ground.

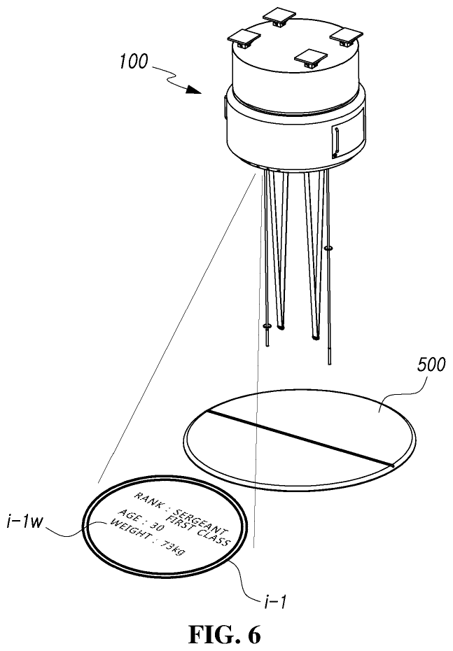

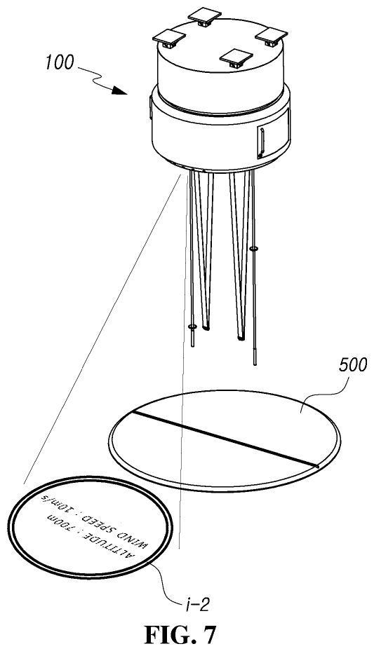

For example, the second driving unit 313 may rotate the output unit 350 in a circumferential direction, thereby changing the direction in which the training information ‘i’ output from the output unit 350 is displayed on the ground, as shown in FIGS. 6 and 7.

Although a case where the direction in which the training information ‘i’ is displayed on the ground is changed by 180 degrees is shown in FIGS. 6 and 7, it is obvious that the direction in which the training information ‘i’ is displayed on the ground may be changed in various manners under the control of an external manager (a training instructor or the like).

Next, the output unit 350 outputs training information ‘i’ about simulated drop training onto the ground through a predetermined light beam. In this case, the predetermined light beam may be, e.g., a laser beam, and accordingly, the output unit 350 may be provided as a laser beam output device.

In this case, the training information ‘i’ according to an embodiment of the present invention is characterized in that it includes at least one of trainee information ‘i-1’ including information about the physical condition of the trainee and landing point information ‘i-3’ indicating the landing point of the trainee according to the landing motion of the training motion.

First, the trainee information ‘i-1’ output through the output unit 350 includes physical condition information including the weight information ‘i-1w’, height information, etc. of the trainee performing simulated drop training, and personal information including the age information, rank information, unit information, etc. of the trainee.

For example, as shown in FIG. 6, the output unit 350 may display the rank information, age information, and weight information ‘i-1w’ of the trainee performing simulated drop training on the ground through a laser beam.

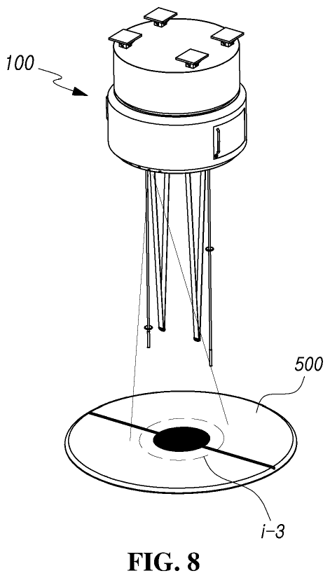

Next, the landing point information i-3 output through the output unit 350 may include information about the position at which the trainee performing landing motion needs to land on the ground during the training motion. For example, as shown in FIG. 8, the output unit 350 may guide the trainee to a landing point by displaying a position, at which the trainee needs to land, on the ground in a circular shape.

Next, the training information ‘i’ according to an embodiment of the present invention may further include training situation information ‘i-2’ including information on a situation in which the simulated drop training is performed.

The training situation information ‘i-2’ output through the output unit 350 may include altitude information, wind speed information, etc., which are information about training conditions for simulated drop training. For example, as shown in FIG. 7, the output unit 350 may display altitude information and wind speed information according to the situation of the simulated drop training on the ground through a laser beam.

Meanwhile, the information display device 300 according to an embodiment of the present invention is characterized in that it changes the color of a light beam according to the training motion and then outputs training information ‘i’.

In this case, the training motion according to the simulated drop training may include lifting motion, aerial motion, and landing motion. The lifting motion is the training motion in which the drop driving unit 200 winds the binding wires 150 so that the trainee is lifted. The aerial motion is the training motion which is performed by the trainee in a state separated from the ground. For example, the aerial motion may include the training motion in which the trainee is rotated by a predetermined angle by manipulating the control wires 170. The landing motion is the training motion in which the drop driving unit 200 unwinds the binding wires 150 so that the trainee lands on the ground.

In this case, the output unit 350 may change the color of a light beam, output onto the ground, according to the type of training motion that is performed by the trainee, and may then output training information ‘i’.

For example, when the trainee performs the lifting motion, the output unit 350 may output a blue light beam and display the training information ‘i’ on the ground. When the trainee performs the aerial motion, the output unit 350 may output a green light beam and display the training information ‘i’ on the ground. In addition, when the trainee performs the landing motion, the output unit 350 may output a red light beam and display the training information ‘i’ on the ground.

Meanwhile, the information display device 300 according to an embodiment of the present invention may change the position at which the training information ‘i’ is displayed on the ground according to the training motion.

For example, when the trainee performs lifting motion or aerial motion, adjustment may be performed by rotating the information display device 300 by a predetermined angle via the first driving unit 311 so that the output unit 350 outputs the training information ‘i’ in front of a base pad 500 to be described later, as shown in FIGS. 6 and 7.

Furthermore, when the trainee performs landing motion, adjustment may be performed by rotating the information display device 300 by a predetermined angle via the first driving unit 311 so that the output unit 350 outputs the training information ‘i’ on the base pad 500, as shown in FIG. 8.

Meanwhile, the information display device 300 according to an embodiment of the present invention may change the direction in which the training information i is displayed on the ground according to the training motion.

For example, when the trainee performs lifting motion, adjustment may be performed by rotating the output unit 350 by a predetermined angle via the second driving unit 313 so that the output unit 350 outputs the training information ‘i’ in the direction in which an external manager (a training instructor or the like) can easily recognize the training information ‘i’, as shown in FIG. 6.

Furthermore, when the trainee performs aerial motion, adjustment may be performed by rotating the output unit 350 by a predetermined angle via the second driving unit 313 so that the output unit 350 outputs the training information ‘i’ in the direction in which the trainee can easily recognize the training information ‘i’, as shown in FIG. 7.

Meanwhile, the information display device 300 according to an embodiment of the present invention may change the content of the training information ‘i’ displayed on the ground according to the training operation.

For example, when the trainee performs lifting motion, the output unit 350 displays the trainee information ‘i-1’, including the physical condition information and personal information of the trainee, on the ground, as shown in FIG. 6.

Furthermore, when the trainee performs aerial motion, the output unit 350 displays the training situation information ‘i-2’, including information about the training conditions of the simulated drop training, on the ground, as shown in FIG. 7.

Furthermore, when the trainee performs landing motion, the output unit 350 displays the landing point information ‘i-3’, including information about the position at which the trainee needs to land, on the ground, as shown in FIG. 7.

Although the color, location, direction, and content of the training information ‘i’ displayed on the ground have been described as being changed according to the training motion that is performed by the trainee, it is obvious that the color, location, direction, and content of the training information ‘i’ displayed on the ground are not necessarily changed according to the training motion and the color, location, direction, and content of the training information ‘i’ displayed on the ground may be changed in various manners according to the design of simulated drop training.

Next, the second control unit 330 is a means for controlling the driving of the above-described driving unit 310 and output unit 350. The second control unit 330 may control the first and second driving units 311 and 313 of the driving unit 310 in response to the driving unit control signal SC-2, and may control the output of the training information ‘i’ of the output unit 350 using the output unit control signal SC-3.

In particular, the second control unit 330 may receive predetermined information or a predetermined signal from the weight sensor 400 or the remote control device 600 to be described later, may generate the driving unit control signal SC-2 and the output unit control signal SC-3 based on the information or signal, and may then control the driving unit 310 and the output unit 350. This will be described in detail below.

Meanwhile, the drop driving unit 200 according to an embodiment of the present invention is characterized in that the weight sensor 400 configured to collect the weight information ‘i-1w’ of the trainee by measuring the load transmitted to the drop driving unit 200 through the binding wires 150 is provided in the drop driving unit 200.

The weight sensor 400 is installed inside the housing 110 to be connected to the binding wires 150 and collect the weight information ‘i-1w’ of the trainee performing the simulated drop training, as shown in FIG. 3.

As described above, the weight sensor 400 is installed to come into contact with the lower surface of the load unit 215, may measure the load transmitted to the rotation unit 210 by the binding wires 150, and accordingly, may calculate and collect the weight information ‘i-1w’ of the trainee who is connected to the binding wires 150 and performs the simulated drop training.

In this case, the information display device 300 according to an embodiment of the present invention is characterized in that it receives the weight information ‘i-1w’ of the trainee from the weight sensor 400 and outputs the training information ‘i’ including the weight information ‘i-1w’ of the trainee.

As shown in FIG. 9, the weight measurement sensor 400 may collect the weight information ‘i-1w’ of the trainee performing the simulated drop training and transfer the weight information ‘i-1w’ to the second control unit 330 of the information display device 300, and the second control unit 330 controls the output unit 350 to output training information ‘i’ including the weight information ‘i-1w’ of the trainee in response to the output unit control signal SC-3.

As shown in FIG. 6, the output unit 350 controlled in response to the output unit control signal SC-3 may include the weight information ‘i-1w’ of the trainee in the training information ‘i’, and may output the training information ‘i’ onto the ground.

Furthermore, the drop driving unit 200 according to an embodiment of the present invention may receive the weight information ‘i-1w’ of the trainee from the weight sensor 400, and may adjust the amount, by which the binding wires 150 are wound, according to the weight information ‘i-1w’ of the trainee.

As shown in FIG. 9, the weight sensor 400 may collect the weight information ‘i-1w’ of the trainee performing simulated drop training and transfer the weight information ‘i-1w’ to the first control unit 250 of the drop driving unit 200, and the first control unit 250 may control the driving motor 230 to adjust the amount, by which the binding wires 150 are wound, according to the weight information ‘i-1w’ of the trainee in response to the driving motor control signal SC-1.

For example, when the weight of the trainee is relatively high, the amount by which the binding wires 150 are wound by the driving motor 230 is controlled to be small, and thus the altitude at which the trainee performs the training operation may be decreased.

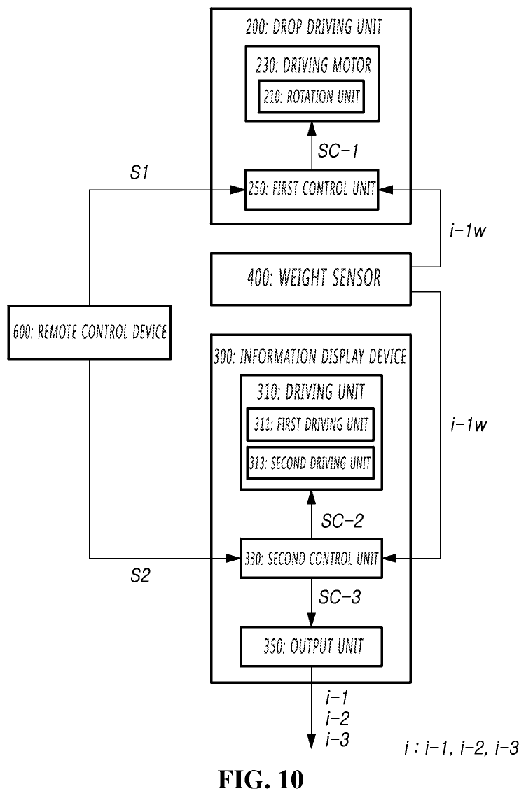

Meanwhile, the simulated drop training apparatus according to an embodiment of the present invention may further include the remote control device 600 configured to remotely control the drop driving unit 200 and the information display device 300, as shown in FIG. 10.

The remote control device 600 may be interconnected with the drop driving unit 200 and the information display device 300 via a wireless communication means such as Wi-Fi, and an external manager (a training instructor or the like) may remotely control the operations of the drop driving unit 200 and the information display device 300 through the operation of the remote control device 600.

For example, an external manager (a training instructor or the like) may operate the remote control device 600 in order to control the winding or unwinding of the binding wires 150 by the drop driving unit 200 according to the training motion of the simulated drop training, and the operation of the drop driving unit 200 may be controlled in response to the drop driving unit control signal S1 generated by the remote control device 600.

Furthermore, an external manager (a training instructor or the like) may operate the remote control device 600 in order to control the content of the training information ‘i’ output from the information display device 200 or the color, position and direction displayed on the ground, and the operation of the information display device 300 may be controlled in response to the information display device control signal S2 generated by the remote control device 600.

Meanwhile, as shown in FIG. 1, the base pad 500 configured to alleviate the impact that is applied to the trainee when the trainee lands on the ground according to the training motion is installed on the ground above which the body part 100 according to an embodiment of the present invention is fixedly installed.

As described above, the training motion performed through the simulated drop training apparatus according to the present invention may include the landing motion in which the trainee lands on the ground from a certain height.

In this case, an unskilled trainee has a very high risk of injury to a leg or the like when performing the landing motion, and thus the base pad 500 is installed at a landing point to prevent injury to the trainee attributable to the performance of the landing motion.

As described above, according to the embodiment of the present invention, the information display device 300 configured to visually display the training information ‘i’ on the ground is provided in the simulated drop training device, so that an external manager, such as a training instructor or the like, or a trainee performing simulated drop training may intuitively become aware of the training information ‘i’, with the result that an effect arises in that the controllability and performance of the simulated drop training are improved.

Furthermore, the weight sensor 400 configured to collect the weight information ‘i-1w’ of a trainee performing simulated drop training is provided in the simulated drop training apparatus and the collected weight information ‘i-1w’ is output via the information display device 300, so that information about the physical conditions of the trainee performing the simulation drop training may be easily determined, with the result that an effect arises in that the safety of the simulation drop training may be secured.

When all the components constituting one of the embodiments of the present invention have been described as being combined into one or as being operated in combination, the present invention is not necessarily limited to the embodiment. In other words, all the components may be selectively combined and operated in one or more within the scope of the object of the present invention.

The above description is intended merely to illustrate the technical spirit of the present invention, and those of ordinary skill in the art to which the present invention pertains may make various modifications and alterations without departing from the essential characteristics of the present invention. Accordingly, the embodiments disclosed in the present invention are not intended to limit the technical spirit of the present invention but to illustrate the technical spirit, and the scope of the technical spirit of the present invention is not limited by these embodiments. The scope of the present invention should be interpreted by the attached claims, and all technical spirits falling within the scope equivalent thereto should be interpreted as being included in the scope of the present invention.

1. A simulated drop training apparatus having a training information display function, the simulated drop training apparatus comprising:
a body part fixedly installed onto a support means that is provided at a simulated drop training site;
a drop driving unit provided inside the body part, and configured to lift or lower a trainee according to training motion by winding or unwinding binding wires connected to the trainee's suit; and
an information display device provided at a lower end of the body part, and configured to output training information about simulated drop training onto a ground through a predetermined light beam.

2. The simulated drop training apparatus of claim 1, wherein the drop driving unit is provided with a weight sensor configured to collect weight information of the trainee by measuring a load transmitted to the drop driving unit through the binding wires.

3. The simulated drop training apparatus of claim 2, wherein the information display device receives the weight information of the trainee from the weight sensor and outputs the training information including the weight information of the trainee.

4. The simulated drop training apparatus of claim 1, wherein the training information includes at least one of trainee information including information about physical conditions of the trainee and landing point information indicating a landing point of the trainee according to landing motion of the training motion.

5. The simulated drop training apparatus of claim 1, wherein the information display device changes a color of the light beam according to the training motion and then outputs the training information.

6. The simulated drop training apparatus of claim 1, wherein the information display device is rotatably coupled to the body part so that a position of the training information displayed on the ground can be changed by adjusting a radiation angle of the light beam.

7. The simulated drop training apparatus of claim 1, wherein a base pad configured to alleviate an impact that is applied to the trainee when the trainee lands on the ground according to the training motion is installed on the ground above which the body part is fixedly installed.
